(19) United States
(12) Patent Application Publication
(10) Pub. No.: US 2018/0374015 A1
(43) Pub. Date: Dec. 27, 2018

(54) SYSTEMS AND METHODS OF ACTIVITY FLOWS IN LIFECYCLE MODELS

(71) Applicant: OPEN TEXT SA ULC, Halifax (CA)

(72) Inventors: Albertus Hendrik Roos, Barneveld (NL); Basanth Kumar Neeli, Hyderabad (IN)

(73) Assignee: OPEN TEXT SA ULC

(21) Appl. No.: 15/993,296

(22) Filed: May 30, 2018

(30) Foreign Application Priority Data
May 30, 2017 (IN) 201741019037

(51) Int. Cl. G06Q 10/06; G06Q 10/10; G06F 3/0484

(52) U.S. Cl. CPC G06Q 10/06311; G06F 3/0484; G06Q 10/1053

(57) ABSTRACT

A managerial-level user can add and specify tasks to define an activity flow using an interactive tool. The activity flow is stored as a building block that is accessible by a process application. A process administrator can insert the activity flow into a stage of a lifecycle of an entity using the process application. The process application may add a reference to the entity to an activity flow definition file associated with the building block stored in the database such that, at runtime of the lifecycle, the activity flow specified by the managerial-level user is automatically executed in the stage of the lifecycle. The process administrator does not need to know how the activity flow was built. The managerial-level user does not need to know how the activity flow is inserted into the lifecycle or how any of its stages work. The activity flows can be customized and reused.

### CROSS-REFERENCE TO RELATED APPLICATION(S)

This application claims a benefit of priority under 35 U.S.C. § 119(a) from Indian Patent Application No. 201741019037, filed May 30, 2017, entitled “SYSTEMS AND METHODS OF ACTIVITY FLOWS IN LIFECYCLE MODELS,” which is fully incorporated by reference herein.

### TECHNICAL FIELD

This disclosure relates generally to the field of process management. More particularly, this disclosure relates to systems, methods, and computer program products for providing customizable activity flows, useful for modeling lifecycles of process management activities in complex process management systems.

### BACKGROUND OF THE RELATED ART

Process management activities can be categorized into various types, for instance, design, modeling, execution, monitoring, and optimization. Such process management activities together can represent a process lifecycle.

A process designer or modeler may create a process and test (modeling) the process to determine how the process might operate under different circumstances. The process can then be executed and monitored (e.g., documented for compliance and/or optimization reasons). The performance information collected from modeling and/or monitoring stages of the lifecycle can be used to enhance the design of the process.

On way to automate a process is to develop or purchase a process management application that executes the required steps of the process. However, users of existing process management applications may view the process differently. Due to the complexity of existing process management applications, these users, for instances, process designers and modelers (e.g., office workers who have no technical background and/or computer programming skills) often cannot customize their process management applications in a streamlined, efficient manner and often must rely on information technology (IT) specialists and/or programmers to address their needs.

In view of the foregoing, there is room for innovations and improvements in the field of process management.

### SUMMARY OF THE DISCLOSURE

Embodiments disclosed herein can address the aforementioned drawbacks and provide additional technical solutions and benefits. An object of the invention is to provide process designers and/or modelers (collectively referred to herein as process builders) with a user-friendly solution to creating, modeling, and customizing process management activities in process lifecycles.

As discussed above, current process management applications may not allow process builders to customize their processes. For example, the modeling tools in current process management applications may not allow process builders to define a sequence of actions or process activities. Further, the modeling tools in current process management applications may not allow process builders to reuse models that they have built.

To this end, one aspect of the user-friendly solution is to make the use of a process management application easier and friendlier to process builders who may have little or no technical knowledge or experience. From a technical standpoint, a goal is to enable any non-technical decision maker to “open up” a process management application and be able to “re-use” process lifecycle models as built.

To achieve this goal, the user-friendly solution provides a process management application in which lifecycle activities can be subtyped to include activity flows. A human resources (HR) application “People Center” from Open Text, headquartered in Canada, can be a non-limiting example of such a process management application.

People Center includes software tools that are particularly configured for HR processes such as employee onboarding, open enrollment, and ongoing payroll and benefits management. These software tools include self-service features that allow HR administrators to define, for instance, how, when, by whom, and what certain tasks, activities, or steps, and in what order, should be performed.

As People Center illustrates, the user-friendly process management solution enables administrators and decision-makers (e.g., managers, directors, officers, executives, etc.) alike to act as process builders and define how activities should flow in a step or stage of a lifecycle of a process (e.g., employee onboarding, invoicing, etc.). To this end, users of the user-friendly process management solution are referred to herein as process administrators, to distinguish them from end users of the process thus created.

In embodiments disclosed herein, an activity flow can define a particular flow of a subset of lifecycle activities (e.g., process activities of a process lifecycle). Put in another way, a process lifecycle can be divided into “activity flows” that can be customized by process administrators.

Previously, each lifecycle can have a set of states (i.e., activities) and a set of relations (which describe how activities are related to one another). Activity flows can complement the features of a lifecycle including states. For example, an activity flow can be initiated when a lifecycle enters into a certain state. Activity flows themselves are stateless and can be linked with relations. Activity flows can be created outside of a process lifecycle. At runtime, an activity flow can be added or linked to a lifecycle model.

There are many advantages of this flexible, user-friendly approach. For example, activity flows can be created independently and exist outside of a lifecycle model/flow. Yet, activity flows can be readily added as subsets of a lifecycle model/flow. They can be easily created, modified, and customized by process administrators. The decoupling also means that a library of activity flows can be created and re-used.

In some embodiments, process administrators can create activity flows via a user interface (UI) of an application (e.g., “People Center”). In some embodiments, the UI may be implemented to provide different ways to create activity flows (for instance, via a graphical approach or a tabular approach) separate and independently of a lifecycle model. Here, “lifecycle” refers to a definition of how and which activities, what milestones (called “states”) are performed to process an entity, such as a purchase order or an invoice, from creation to closure.

For example, in some embodiments, activity flows can even be created independent of a process management application and/or of any process building experience. For example, they can be created using a process platform administration application or an activity flow editor. Such an editor can have a streamlined UI and is operable to interact with a decision-maker such as a manager, director, officer, or any authorized user who need not be a programmer or know how to use a process management application. The decision-maker interacts with the editor to provide input data to an activity flow. The editor is operable to create the activity flow based on the input data and store the activity flow in a database that is accessible by a process management application. In this way, decision-makers can be shielded from the complexity of process building and do not even need to know how to use a process management application.

Novel features of embodiments disclosed herein may include, but are not limited to, atomic stateless activity flows, representing smaller pieces of a lifecycle model, and ease of creation of activity flows so that process administrators can create, modify, and customize activity flows as needed or desired. For example, with activity flows, process administrators can easily create and customize a sequence of actions, something that was not possible in previous process management applications.

In some embodiments, a managerial-level user can log into an activity flow editor. The activity flow editor can run on the managerial-level user's computer. Alternatively, the activity flow editor can be hosted at the backend (or in the cloud) and provide a user interface to the managerial-level user on the managerial-level user's computer. The user interface of the activity flow editor has a tasks menu for adding tasks to define an activity flow.

In some embodiments, responsive to an instruction from the managerial-level user to add a task to the activity flow, the activity flow editor may prompt the managerial-level user to provide task details and any follow-up task for the task. A follow-up task can have its own task details and follow-up task(s). Through this interactive process, the managerial-level user can specify all the tasks needed to complete an activity flow.

The activity flow editor is operable to store the activity flow as a building block in a database or a data store. The activity flow contains task(s), task details, and any corresponding follow-up task(s) specified by the managerial-level user. The activity flow thus stored is accessible by a process application.

Responsive to a process administrator inserting the building block into a stage of a lifecycle of an entity using the process application, the process application may add a reference to the entity to an activity flow definition file associated with the building block stored in the database such that, at runtime of the lifecycle, the activity flow specified by the managerial-level user is automatically executed in the stage of the lifecycle. From the system's perspective, the activity flow is represented as an entity for querying at runtime.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of an activity flow in a graph structure according to some embodiments.

FIG. 2 depicts a diagrammatic representation of an example of a user interface of a process management application showing an activity flow according to some embodiments.

FIG. 3 depicts a diagrammatic representation of an example of a user interface of a process management application showing a customized activity flow according to some embodiments.

FIG. 4A depicts a diagrammatic representation of an example of a user interface of a process platform administration application through which an activity flow can be customized according to some embodiments.

FIG. 4B depicts a diagrammatic representation of an example of a user interface of a process platform administration application through region-specific activity flows can be created according to some embodiments.

FIGS. 5A-5G and 6 depict diagrammatic representations of screenshots from a user interface through activity flows can be created according to some embodiments.

FIG. 7 depicts a diagrammatic representation of an example of a user interface of an entity-based process application according to some embodiments.

FIG. 8 depicts a diagrammatic representation of an example of a user interface of an entity-based process application showing how an activity flow can be readily added to the lifecycle of an entity-based process flow according to some embodiments.

FIG. 9 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

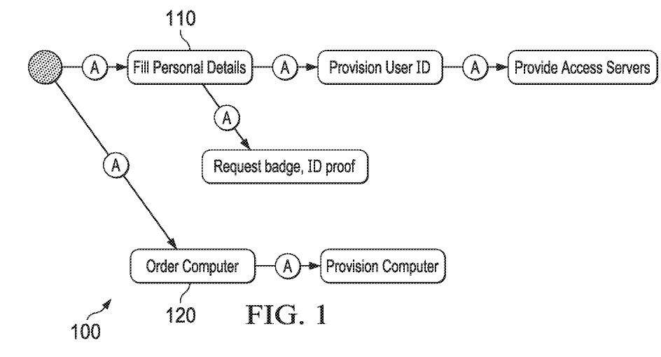

FIG. 1 depicts a diagrammatic representation of an example of activity flow 100 in a graph structure according to some embodiments. In this case, a process administrator can graphically define a sequence of steps (or activities) using UI elements such as boxes and arrows (or links). The boxes may represent activities in a process (e.g., IT provisioning) and the links may represent relations among the activities in the process. As a non-limiting example, IT provisioning activity flow 100 may include “Fill Personal Details,” “Provision User ID,” “Provide Access Servers,” “Order Computer,” “Provision Computer,” and “Request badge, ID proof” activities.

In the example of FIG. 1, “A” denotes an “automatic” action or execution. In this case, activity 110 and activity 120 may take place simultaneously or in parallel. Although not shown in FIG. 1, the activities can have applicability conditions. For example, if a condition does not match, the activity can be skipped and not applied. The links can also have applicability conditions. For example, a branch will not start if a condition is not matched. In some cases, an activity in the activity flow can itself be another activity flow. Such an activity may be referred to as a composite activity.

In some cases, a process administrator can define a sequence of steps (or actions) in a grid pattern or structure, rather than in a graph structure. Such a grid structure can be represented in a particular data structure, such as rows in a table or spreadsheet, with each row corresponding to a step in a process and each step can have one or more activities.

In some embodiments, activity flows can be created and/or modifiable by process administrators at runtime (e.g., using process management user interfaces of an application such as People Center). This means that process administrators do not have to rely or wait on information technology (IT) specialists and/or programmers to perform activity flow customizations. To enable such runtime customizations, the underlying process management system which supports the process management application at the frontend is updated at design time. The process management system can be a highly complex enterprise system operating at the backend of an enterprise computing environment.

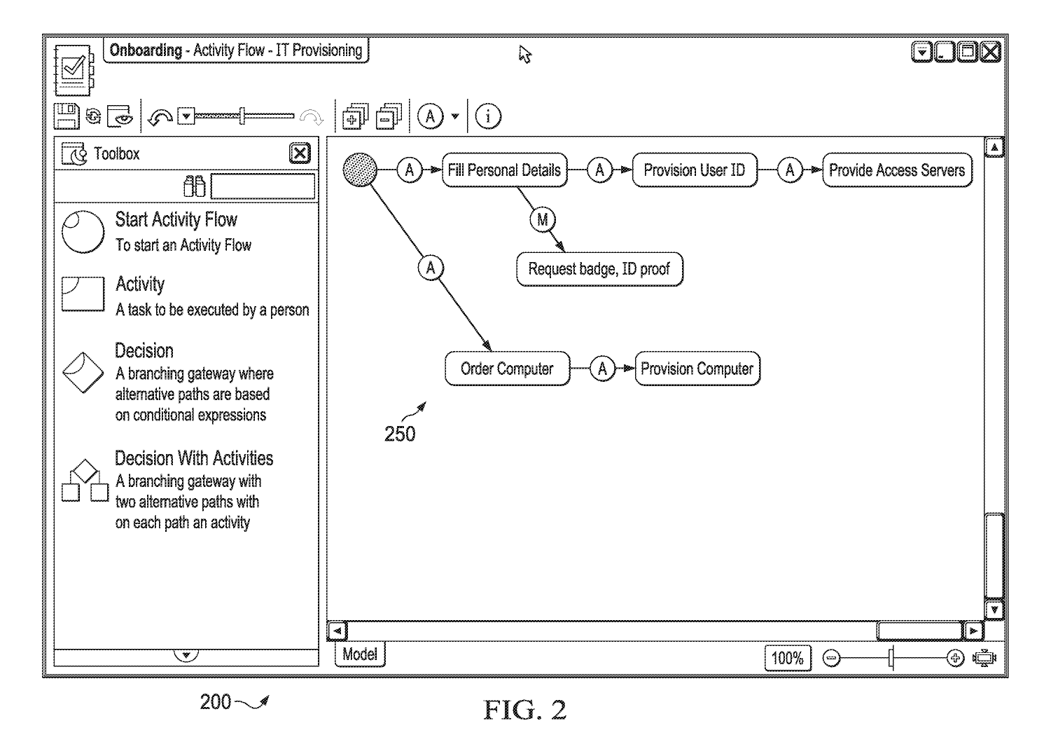

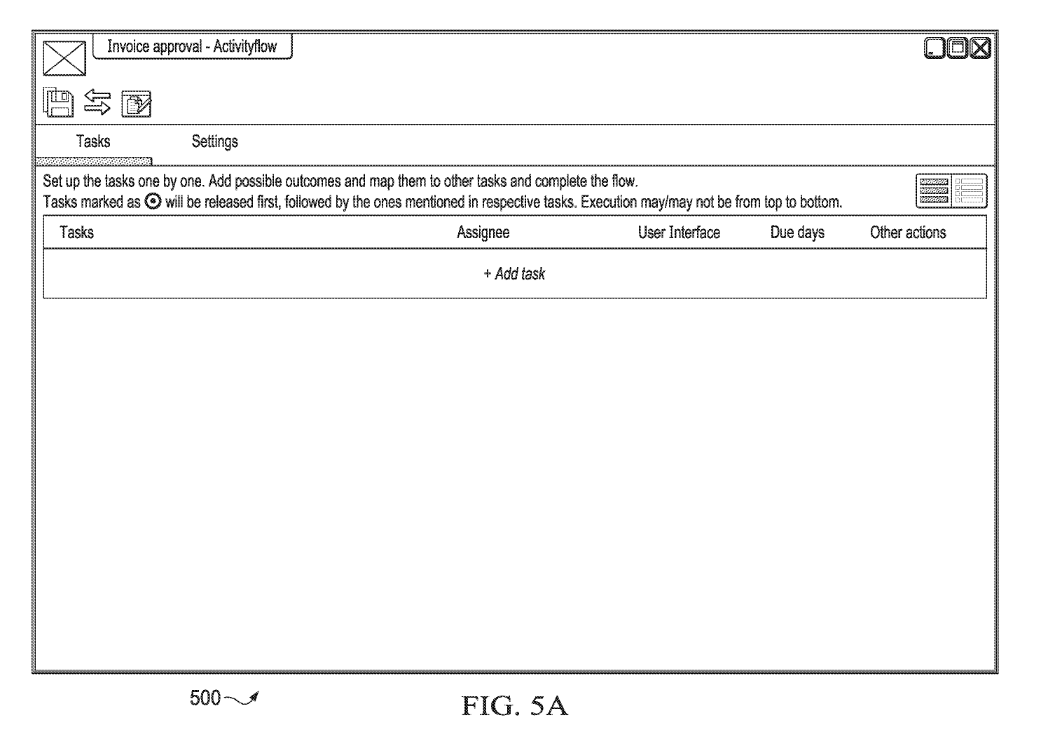

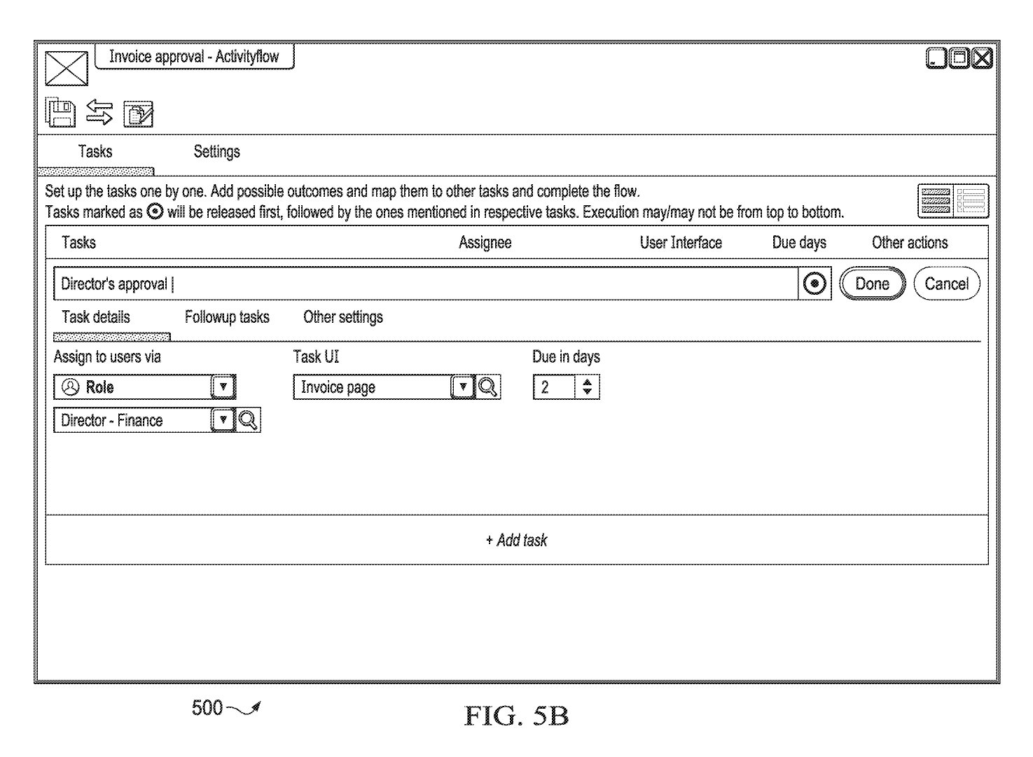

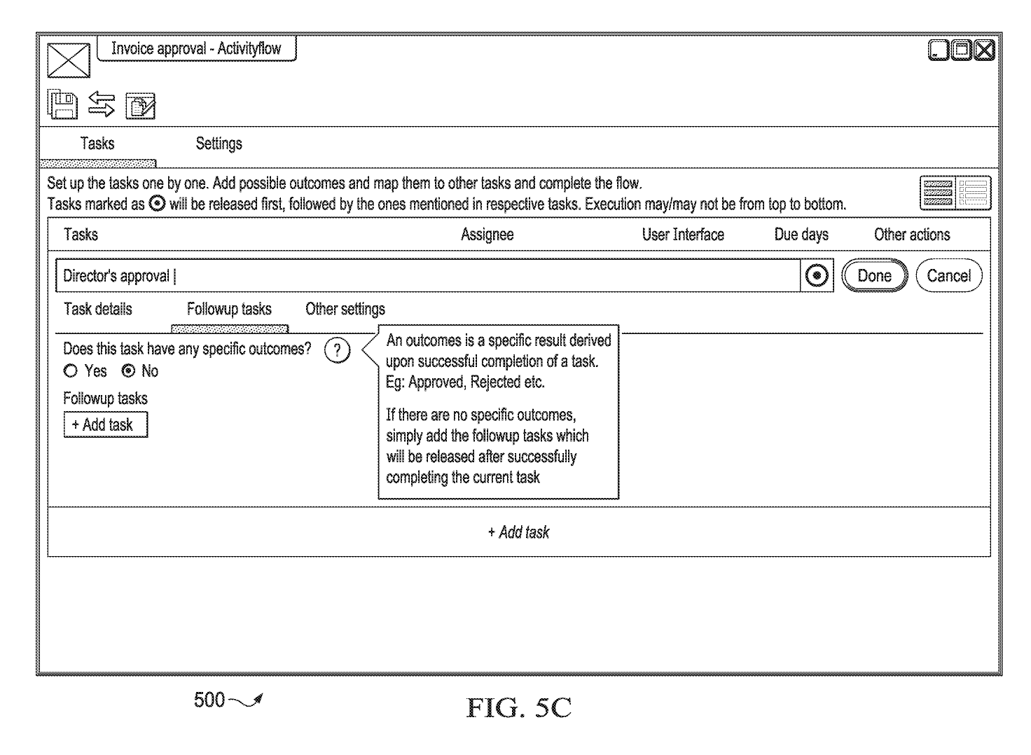

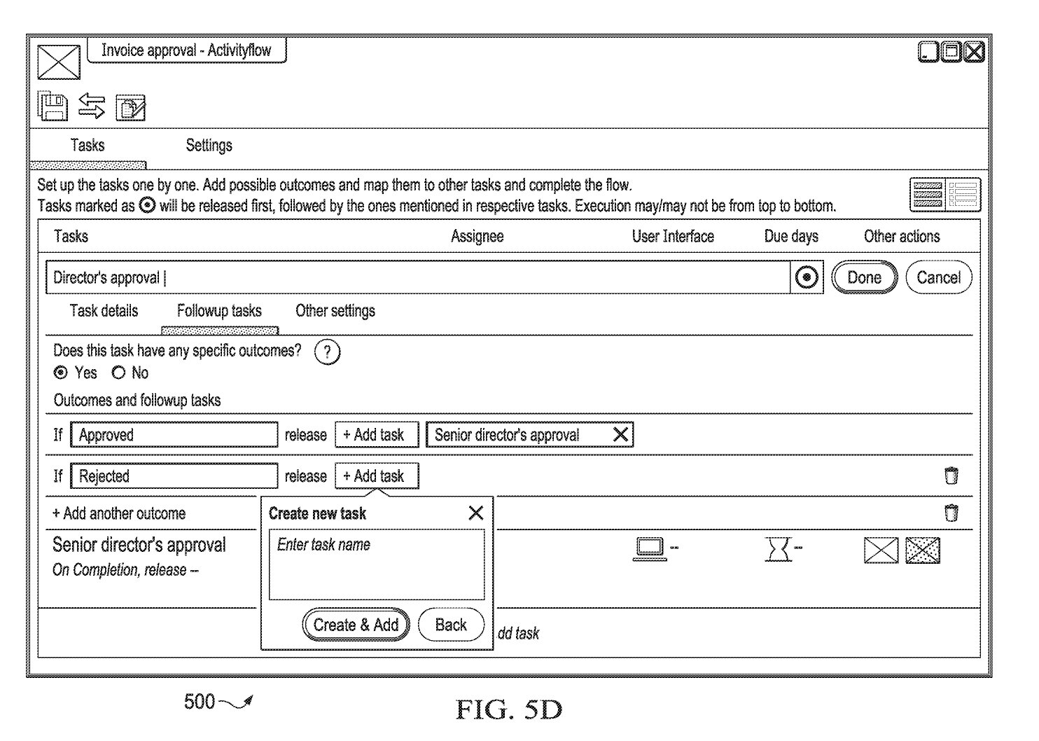

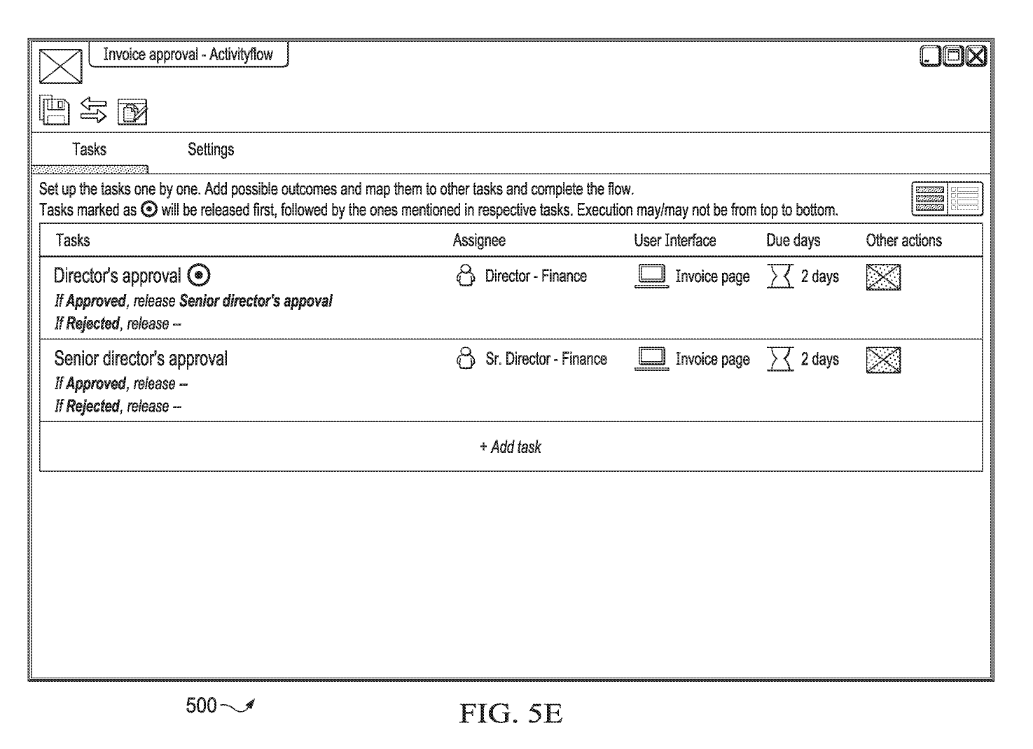

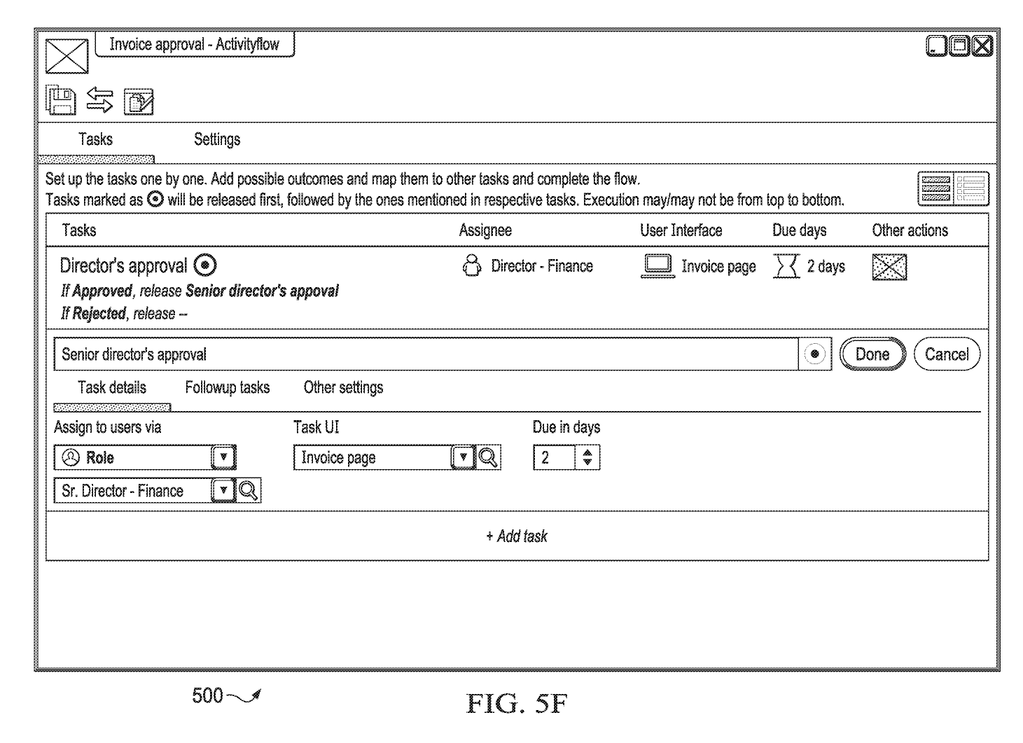

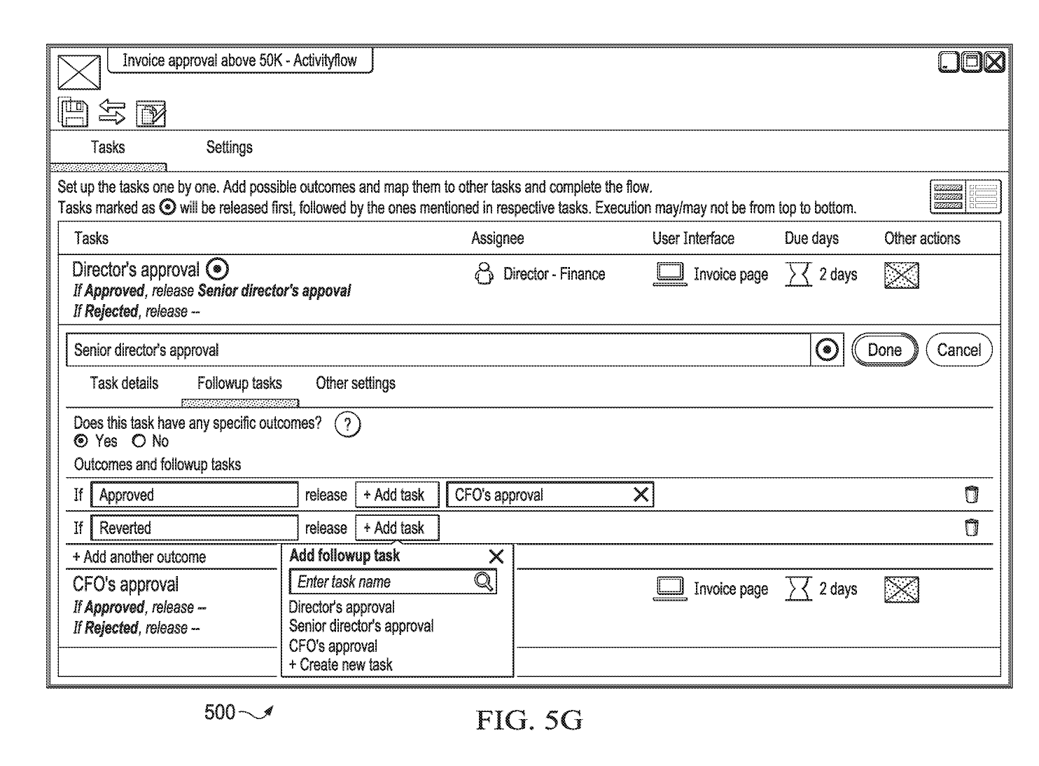

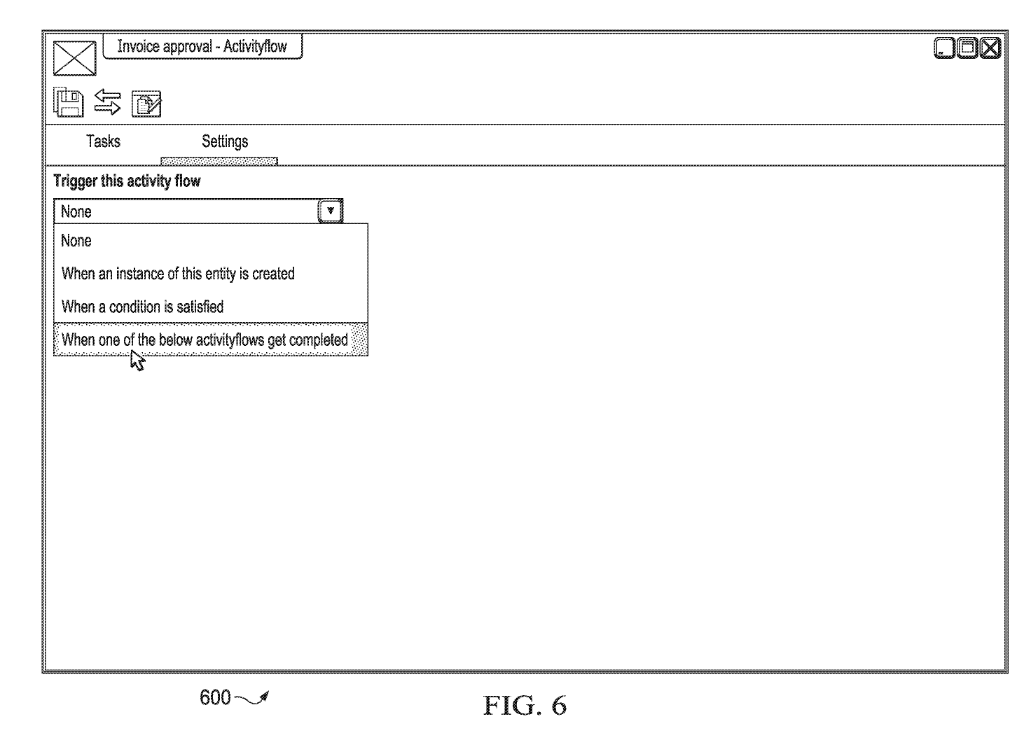

Whether created graphically (see, e.g., FIG. 2), through a grid structure (e.g., a table or spreadsheet), or interactively using an activity flow editor as described below (see FIGS. 5A-6), an activity flow thus created is a new type of entity building block (referred to herein as “building block”). The concept of composing entities using building blocks is realized in a compositional entity modeling system described in U.S. Patent Application Publication No. US 2016/0378437 A1, which is fully incorporated by reference herein. The compositional entity modeling system runs on an application development platform for creating process solutions (e.g., frontend user-friendly applications such as a process management application, a process platform administration application, an entity-based application, etc.) that leverage functionality from various enterprise systems such as case management, process management, content management, and systems integration. To this end, the compositional entity modeling system can provide an application framework for developing entity-driven process applications.

Examples of suitable application development platforms may include “low-code” application development platforms. A low-code application development platform can be defined as one that enables fast application development and delivery with a minimum of manual/hand coding. A low-code application development platform should be easy to deploy and is likely to be used to develop customer-facing software systems. Generally, a low-code application development platform uses visual models to define the various elements of an application, reducing the need for hand-coding and accelerating the development process.

The low-code application development platform may comprise elements that particularly define the entity modeling system and items that can be created by users of the entity modeling system (e.g., documents, forms, cases, process models, etc.). What is in an item can be defined by a set of elements that have been assembled into an object. The elements and items on a server machine can be partitioned into separately managed solutions.

In this context, a plurality of building blocks can represent a subset of the elements of the entity modeling system operating on the application development platform. Accordingly, all building blocks are elements of the entity modeling system, but not all elements are building blocks.

Each building block comprises code instantiated from a class to implement certain settings that can be added to an entity. Such settings may be structural, decorative, and/or functional. Decorative and functional building blocks can be treated the same way, for instance, as structural building blocks. Building blocks can be used by entity model builders to assemble or compose entities in a particular project via an entity model designer tool of the entity modeling system. Some building blocks can be added to an entity many times, while some building blocks can only be added once. Accordingly, an entity serves as a holder of a particular collection of building blocks. Since building blocks can be created and managed separately and independently of the entities, there is an open-ended set of possible building blocks that can be added to the entities being modeled. This provides a flexible model for extension (e.g., actions, properties, behaviors, user experience (UX) panels, permissions, REST application programming interfaces (RESTful APIs), etc.).

A process builder may interact with an entity composition function provided by the entity modeling system, for instance, by selecting an add function. Responsive to the user interaction with the entity composition function, the entity modeling system may access a data store or database (e.g., over a network in a distributed computing environment) where building blocks are stored, generate a second view including building blocks, and display the second view. To add a building block from the second view to the entity, the process builder can select a building block from the second view, whereupon the entity modeling system may automatically extend the entity to include the settings of the selected building block to the entity. The settings may include at least one of a property, a permission, an action, a behavior, or a resource.

Building blocks in an entity modeling system can be arbitrarily divided into broad building block categories/types that can be added to an entity. For example, building blocks may be sorted into the following types:

Structural building blocks that define the fundamental nature of an entity (e.g., Property, Relation, Rule, etc.);

Functional building blocks that add “chunks” of functionality to an entity (e.g., Activity Flow, Security, History, Title, Tracking, etc.); and

Decorative building blocks that specify how users can interact with entities (e.g., Worklist, Form, Layout, Action Bar, etc.).

Below is a non-limiting list of example building blocks that can be used to construct an entity.

Structural building blocks:

Properties—adds the ability to define structured groups of properties.

Relationships—specify how this entity relates to other entities.

Rules—adds the ability to add rules to an entity to specify process logic or to create custom actions.

Functional building blocks:

Activity Flow—adds the ability to perform a flow of tasks, for instance, in a lifecycle model (e.g., as a particular flow of a subset of lifecycle activities) that can be created by decision-makers outside of lifecycle modeling and that can be readily customized and/or repeated for different applications.

History—adds the ability to track changes to instances of entities in a history log (an audit trail). For example, it may keep track of when instances are created and when these are last modified and by whom.

Security Policies—adds the ability to define security policies that control access to instances of an entity.

Title—adds a Title that can be used to identify instances of the entity. Having a title on an entity enhances the readability of history linkable where used entries, etc.

Tracking—adds date/time created and last modified and user who created/last modified instances of the entity.

Decorative building blocks:

Action Presentations—specifies a presentation for the entity's actions. Multiple action presentations may be defined for use in different layouts or for use by different personas.

Forms—specifies a presentation for the entity's properties. An entity's form may include information from parent, child or other related entities. Multiple forms may be defined for use in different layouts or for use by different personas.

Layouts—specifies an overall presentation of an instance of the entity. Multiple layouts may be defined for use by different personas or different states of an instance of the entity.

Worklists—adds the ability for end users to access lists of instances of the entity. Any number of worklists may be added to an entity and access to worklists can be controlled by security.

As described above, some building blocks (e.g., decorative building blocks) the can be added to an entity definition multiple times (and are therefore presented under a group card in one embodiment). Most building blocks can only be added once (for example, an entity either has History or it does not). In one embodiment, those that can be added multiple times are presented as a stacked card that can be expanded to see the individual building blocks. In one embodiment, the first time a given type of build block is added, the group card is automatically added. Deleting the last instance of a grouped building block deletes the group card.

Structural and function building blocks can alter the basic structure of an entity. For example, adding, removing and, in some cases, changing the settings on these building blocks can change underlying database representation of the entity. For the most part, this is neither visible nor important to the solution builder. However, a builder is not permitted to add, remove or alter these building blocks in external entities (see below).

The definitions for some building blocks (e.g., Security Policies, Action Presentations,

Forms, Layouts, Worklists, etc.) can be large and complex. Adding such a large and complex building block may entail opening a new window or tab in the entity model designer tool, as described above.

Some building blocks have additional functionality when used in conjunction with other building blocks. For example, when the Status and Assign building blocks are used together, additional security permissions are exposed to enable only the Assignee to change the Status.

As described above, the compositional entity modeling system can provide an application framework for developing entity-driven process applications on a low-code application development platform. In this context, a “main” entity (e.g., an entity created as a root node of a process) can have a one-to-many relationship with a plurality of building blocks. An activity flow can be one of the plurality of building blocks. The activity flow can use features (e.g., execution logic, case models, etc.) available through the compositional entity modeling framework. Other building blocks for the entity can include rules, properties, etc. for the entity. The properties of the entity can be accessed using a proprietary entity expression language, e.g., “item.properties.proName.”

As an activity flow itself can be a composition of entities, its properties can be accessed using an expression language item, e.g., “Activityflows[n].ActivityFlowlnstance.proName.”

An activity flow can work with a security building block for access permissions.

Below is a non-limiting example of an entity composed from building blocks:

```
<EntityNative type=“ ” >
  <Name>Invoice</Name>
    <Description>Invoice</Description>
      <BuildingBlocks>
        <IdentityBuildingBlock type=“ ”>
        <ActivityflowBuildingBlock type=“ ” >
        <PropertyBuildingBlock type=“ ”>
      </BuildingBlocks>
      <Original/>
      <Supertype/>
</EntityNative>
```

In this example, entity “Invoice” is composed of three building blocks: identity, activity flow, and property. The “Original” flag indicates whether the entity is original or customized. The “Supertype” flag indicates whether the entity is subtyped (inherited) from another entity. Customization (discussed below) and subtyping are features on the entity level.

As a non-limiting example, the definition for the activity flow (as a building block for the “Invoice” entity) can be as follows:

```
<ActivityflowBuildingBlock type=“ ” typeVersion=“...”>
  <Name>ActivityFlow</Name>
  <Activityflows>
    <Activityflow type=“ >
      <Name>Invoice Approval</Name>
      <Description>Approval</Description>
      <TriggerType>onACondition</TriggerType>
      <activityflowCategory/>
      <ChainingEvents/>
      <EntityCaseModel>
        <CMCaseModel type=“ ” />
        <DesignerInfo>
          <GMFDiagramInfo type=“ ” />
        </DesignerInfo>
        <HandlingModels>
          <CMCaseHandlingModel type=“ ” >
            <Activities>
            <Events>
            <Followups>
            <CaseModel>
        </HandlingModels>
      </EntitycaseModel>
      <TriggerExpression>
        <EntityExpression type=“ ” typeVersion=“...” >
      </TriggerExpression>
      </ActivityFlow>
      <Activityflow/>
    </Activityflows>
    <InlinedEntities>
  <EntityNative type=“ ”>
  </InlinedEntities>
</ActivityflowBuildingBlock>
```

In the above example, the activity flow can be triggered on a condition. There can be many types of triggers: manual or automatic on a condition (rule), part of a lifecycle, chained to another activity flow, etc. In this case, the case model holds the definition of activities in the activity flow and can be compiled to, for instance, SCXML (State Chart XML—an XML-based markup language that provides a generic state-machine based execution environment). Below is a non-limiting example of an executable activity flow definition:

```
<CaseModel>
  <caseproperties>
  <businessevents/>
  <followups/>
  <scxml initialstate=“RootCaseModelState”>
    <state id=“RootCaseModelState” name=“Default State”
initialstate=“”>
      <onentry/>
      <state id=“...” name=“In Progress”>
        <onentry>
          <releaseactivity name=“Product Availability”
srctype=“LOCAL” activitycluster=“StateCluster_In Progress”/>
        </onentry>
        <transition event=“ ” cond=“” target=“final_state”/>
      </state>
    <transition event=“Case.close” target=“final_state”/>
    </state>
    <final id=“final_state”/>
</CaseModel>
```

At runtime, rules are evaluated for any change in the entity and, if an activity flow is linked to a rule action, the activity flow is initiated. When an activity flow is added as a step in a lifecycle, it can be automatically executed or implemented to be manually triggered, for instance, through a button presented in a UI. An activity flow can also be automatically initiated after completion of another activity flow (chained). As the activity flow is executed, the execution details can be stored in a database table (e.g., as columns). The activity flow definition can hold a reference to the entity. This allows the execution details of the activity flow to be stored in association with the entity.

Wth embodiments disclosed herein, process administrators do not need to know how to generate the code examples shown above. Rather, a process administrator can utilize a user-friendly process application to create an activity flow in a low-code application development environment, for instance, graphically as shown in FIG. 1 and further described below. The system automatically generates the necessary code exemplified above. Similarly, when a condition is specified by a processor administrator (e.g., by dragging and dropping a condition element in a process flow), the system translates the condition and corresponding action and creates a corresponding system-defined rule which can then be executed at runtime. An activity flow thus created can be used and configured like other building blocks described in U.S. Patent Application Publication No. US 2016/0378437 A1.

As discussed above, activity flows can be created independently of process lifecycles. However, an activity flow can be added and linked to a lifecycle of an entity (e.g., an “IT provisioning” activity flow can be added to the lifecycle of the entity “employee onboarding”). An activity flow thus linked to the lifecycle can be stored as an activity definition that can be executed at runtime.

Activity flows can be modified or otherwise customized from within a lifecycle model in a lifecycle modeling environment provided by a process management system.

FIG. 2 depicts a diagrammatic representation of an example of process management application UI 200 showing activity flow 250 “IT Provisioning” added as a new building block of an entity “Onboarding.” In this example, a process administrator is building an entity-based process application for employee onboarding. The process application has “Onboarding” as the “main” entity. The “Onboarding” entity has a lifecycle that goes through several stages, one of which is for “IT Services.” In this case, activity flow 250 “IT Provisioning” can be added to the “IT Services” stage as a building block for the entity “Onboarding.” Multiple stages of the process application can have an activity flow. Further, a stage can have multiple activity flows.

For the sake of illustration and not of limitation, to define “IT Provisioning” activity flow 250, a process administrator can drag and drop activities or tasks “Fill Personal Details,” “Provision User ID,” “Provide Access Servers,” “Order Computer,” “Provision Computer,” and “Request badge, ID proof” (e.g., from the “Activity” folder) onto UI 200. Notice in this example, the relation (link) between the “Fill Personal Details” activity and the “Request badge, ID proof” activity is denoted with an “M” indicating that, at runtime (e.g., when used in the entity-based process application “Onboarding”), execution of “IT Provisioning” activity flow 250 may result in a prompt being generated and presented to an end user (e.g., a user of the entity-based process application “Onboarding”) to perform the “Request badge, ID proof” activity or task after the “Fill Personal Details” activity is automatically executed.

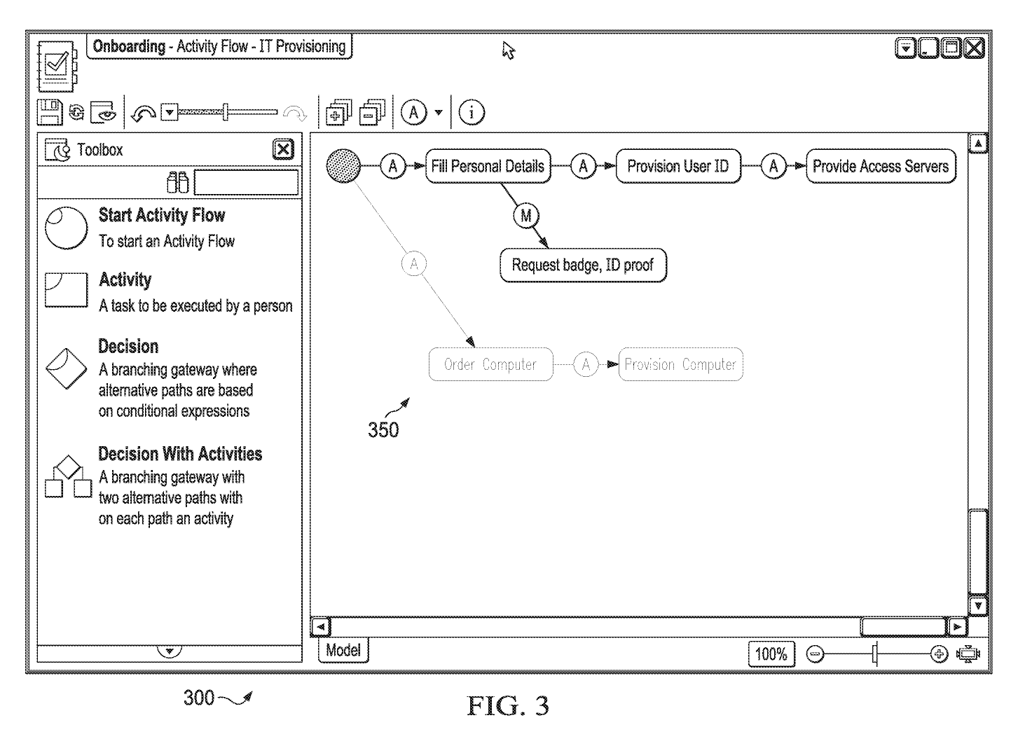

FIG. 3 depicts a diagrammatic representation of an example of process management application UI 300 showing customized activity flow 350. In this example, activity flow 350 is a customized version of activity flow 250 shown in FIG. 2. In a customization, an activity or task in a flow can be disabled or an activity or task (e.g., from the “Activity” folder) can be added to the flow, etc. In the example of FIG. 3, the “Order Computer” and “Provision Computer” activities of customized activity flow 350 are grayed out, indicating that these activities are disabled and will not be run when customized activity flow 350 is executed.

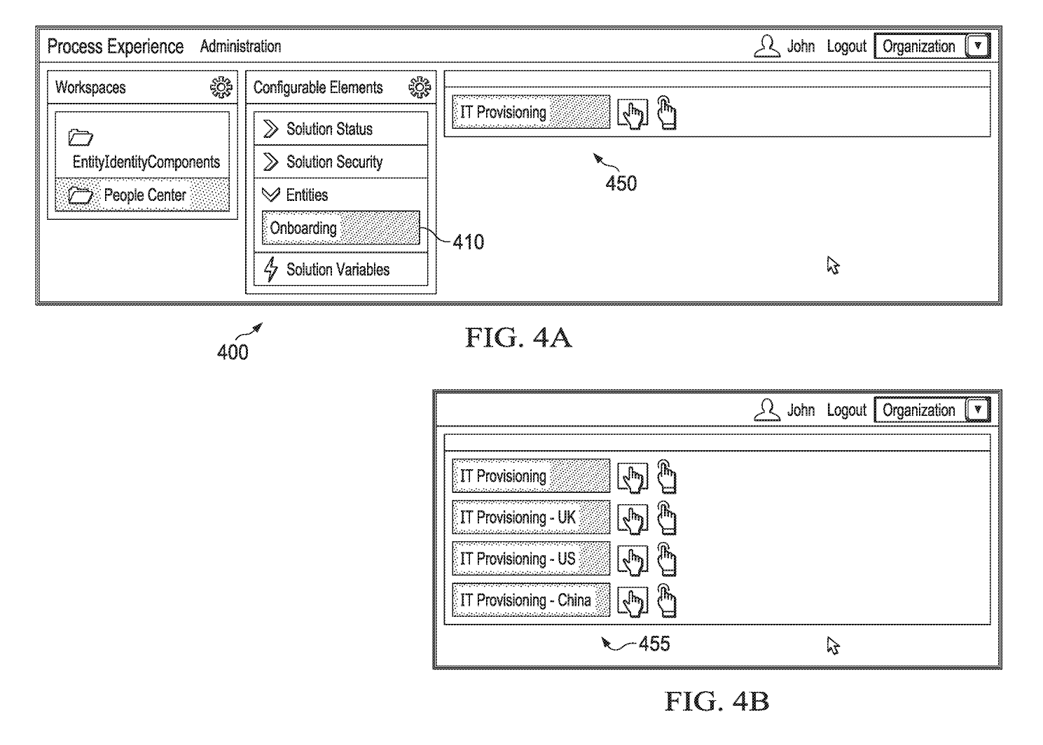

Each customization can be saved as a draft. A customized activity flow can be published to runtime just like any activity flow, etc. Activity flow creation and customization can be done using a process management application (e.g., People Center) or using a process platform administration application (e.g., Process Experience Administration shown in FIG. 4A, which includes People Center as one of the workspaces accessible through Process Experience Administration). Activity flows created and/or customized using embodiments disclosed herein can be invisible to end users.

FIG. 4A shows an example of UI 400 of a process platform administration application through which activity flow “IT Provisioning” 450 for entity “Onboarding” 410 can be added. Customized activity flows can also be added. For example, the same “IT Provisioning” activity flow may be customized for different geographic regions and added as region-specific activity flows 455, as illustrated in FIG. 4B. At runtime, an end user may be prompted to indicate, for instance, a geographic region, but the end user is unaware of the existence of any activity flow. Here, geography is used as a non-limiting example. Activity flow customization is possible on any criterion. Once the input is received from the end user, a decision can be made to run a particular “IT Provisioning” activity flow specifically customized for the geographic region at design time and selected by the end user at runtime. In a non-limiting example, a relational database overlying an XML document store or repository can be implemented to store data related to various activity flow customizations.

As described above, activity flows can be created by process administrators (e.g., using a graphical approach) using process applications built on the compositional entity modeling framework described in the above-referenced U.S. Patent Application Publication No. US 2016/0378437 A1. Other implementations are also possible. For example, activity flows can be implemented in an entity-based process application using an application package called Identity Package configured for managing users, roles, organizational units, and worklists and including an interactive tool for mapping them and creating activity flows (referred to herein as an activity flow editor).

FIG. 5A depicts a diagrammatic representation of an example of UI 500 of an activity flow editor through activity flows can be created according to some embodiments. Unlike a process management application, the activity flow editor does not have a drag-and-drop canvas for creating a process or an activity flow. Rather, the activity flow editor is an interactive tool where a managerial-level decision-maker (referred to herein as a managerial-level user) can create an activity flow by setting up what role-specific tasks should be performed, when, how, and by whom. The managerial-level user can be a company's director, manager, officer, executive or whoever is familiar with what and how tasks are performed. To use the activity flow editor, the managerial-level decision-maker does not need to have any programming experience or familiarity with application development.

As illustrated in FIG. 5A, UI 500 is streamlined with just a few features or functions (e.g., through a tasks tab and a settings tab) to shield the complexity of the underlying process building system from the managerial-level user. As shown in FIG. 5B, under the tasks tab, the managerial-level user can set up tasks one by one, by naming a task, assigning the task to a role or roles under his or her management, and setting a due date.

As shown in FIG. 5C, the managerial-level user can set up follow-up tasks and specify whether the task has any specific outcomes. When a task has specific outcomes (e.g., approved or rejected), the managerial-level user can further specify what follow-up tasks should be performed. As shown in FIG. 5D, the task “Director's approval” has a specific outcome that requires a follow-up task (e.g., “If Approved, release Senior director's approval.”). Accordingly, the managerial-level user can add the follow-up task “Senior director's approval” to the tasks tab. As shown in FIG. 5E, once added, both tasks (in this example, the original task “Director's approval” and the follow-up task “Senior director's approval”) are visible in the tasks tab of the activity flow editor for an activity flow “Invoice approval.” The managerial-level user can drill down to a task listed and provide and/or modify (e.g., by selecting from a predetermined menu of items and/or filling out an input field) associated task details. In the example shown in FIG. 5G, the follow-up task “Senior director's approval” also has a follow-up task “CFO's approval” which the managerial-level user can select from a predetermined menu of tasks.

Once all the tasks (activities) of the activity flow have been specified, the managerial-level user can specify how the activity flow is to be triggered. For example, as shown in FIG. 6, the managerial-level user can select from a predetermined menu (e.g., no trigger, trigger when an instance of the entity “Invoice” is created, when a condition or rule is satisfied, when another activity flow is completed, etc.). Other activity flow triggers are also possible.

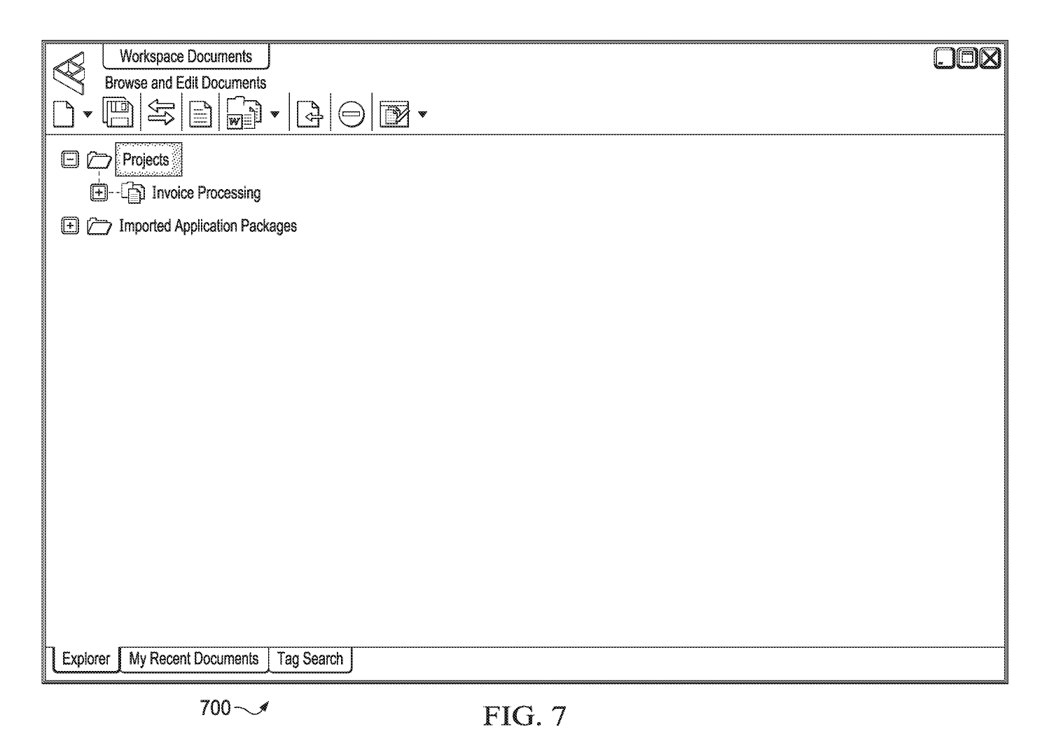

Activity flows thus created by a managerial-level user can be used by process administrators and process builders alike in creating useful process solutions customized for various scenarios, an example of which is shown in FIG. 7.

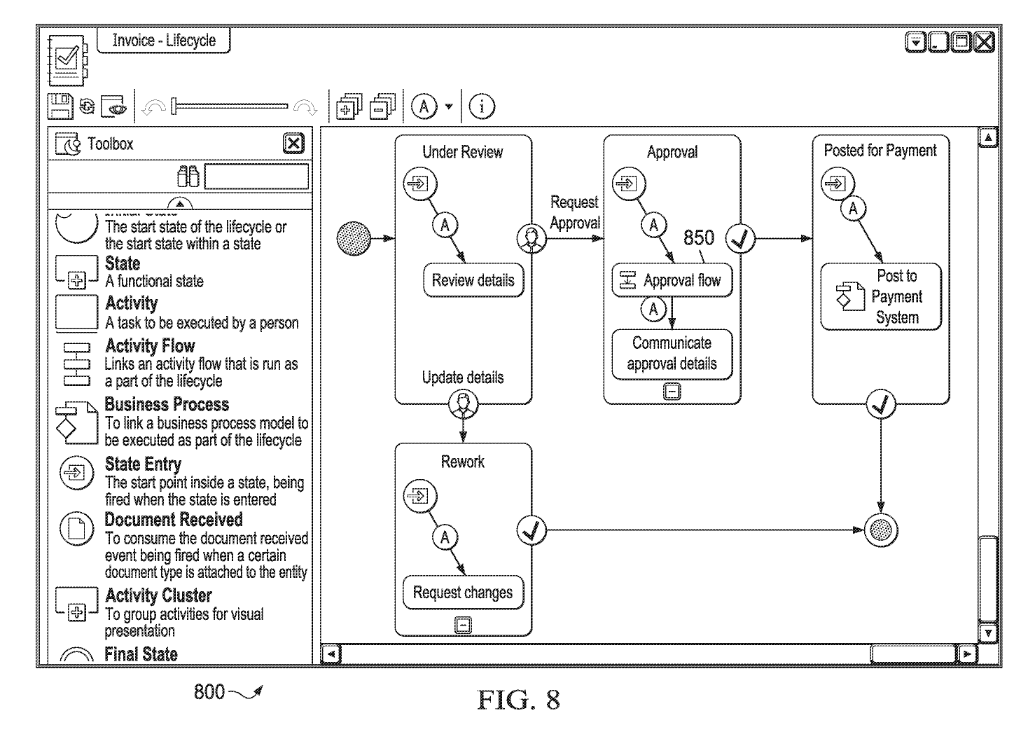

In the example of FIG. 7, a process administrator may log in to an entity-based process application and creates a project “Invoice Processing.” Technically, “Invoice Processing” is an application and invoice is an entity that can be composed using building blocks of the compositional editing modeling framework. As shown in FIG. 8, the invoice (entity) has a lifecycle that is made of several stages (e.g., “Under Review,” “Rework,” “Approval,” and “Posted for Payment”). In this example, the process administrator may add a previously created activity flow 850 “Approval flow” to the “Approval” stage (e.g., by using the “Activity Flow” tool to insert activity flow 850 into the “Approval” stage).

On the one hand, the process administrator does not need to know how activity flow 850 was built. On the other hand, the managerial-level user who created activity flow 850 does not need to know how activity flow 850 is inserted into the lifecycle of “Invoice Processing” or how any of its stages work. In this way, embodiments disclosed herein not only allow process builders and process administrators to create and customize their processes (including lifecycles), but also allow managerial-level users to create and customize activity flows that can then be used and reused by process builders and process administrators in creating and customizing process solutions appropriate for their needs.

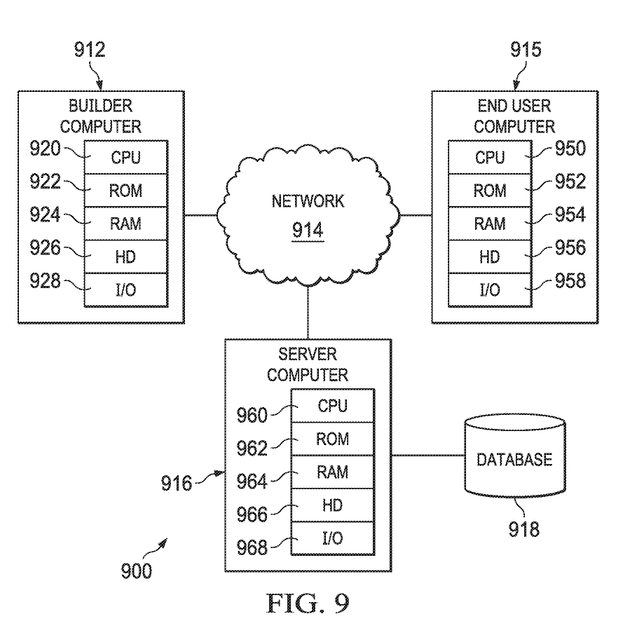

FIG. 9 depicts a diagrammatic representation of a distributed network computing environment where embodiments disclosed can be implemented. In the example illustrated, network computing environment 900 includes network 914 that can be bi-directionally coupled to computer 912, computer 915, and computer 916. Computer 916 can be bi-directionally coupled to data store 918. Network 914 may represent a combination of wired and wireless networks that network computing environment 900 may utilize for various types of network communications known to those skilled in the art.

For the purpose of illustration, a single system is shown for each of computer 912, computer 915, and computer 916. However, with each of computer 912, computer 915, and computer 916, a plurality of computers (not shown) may be interconnected to each other over network 914. For example, a plurality of computers 912 and a plurality of computers 915 may be coupled to network 914. Computers 912 may include data processing systems for communicating with computer 916. Computers 912 may include data processing systems for process administrators whose jobs may require them to design, build, and/or customize processes used in network computing environment 900.

Computer 912 can include central processing unit (“CPU”) 920, read-only memory (“ROM”) 922, random access memory (“RAM”) 924, hard drive (“HD”) or storage memory 926, and input/output device(s) (“I/O”) 928. I/O 928 can include a keyboard, monitor, printer, electronic pointing device (e.g., mouse, trackball, stylus, etc.), or the like. Computer 912 can include a desktop computer, a laptop computer, a personal digital assistant, a cellular phone, or nearly any device capable of communicating over a network. Computer 915 may be similar to computer 912 and can comprise CPU 950, ROM 952, RAM 954, HD 956, and I/O 958.

Likewise, computer 916 may include CPU 960, ROM 962, RAM 964, HD 966, and I/O 968. Computer 916 may include one or more backend systems configured for providing content web services (CWS) over network 914. In some embodiments, activity flow information may be stored in data store or database 918. Many other alternative configurations are possible and known to skilled artisans.

Each of the computers in FIG. 9 may have more than one CPU, ROM, RAM, HD, I/O, or other hardware components. For the sake of brevity, each computer is illustrated as having one of each of the hardware components, even if more than one is used. Each of computers 912, 915, and 916 is an example of a data processing system. ROM 922, 952, and 962; RAM 924, 954, and 964; HD 926, 956, and 966; and data store 918 can include media that can be read by CPU 920, 950, or 960. Therefore, these types of memories include non-transitory computer-readable storage media. These memories may be internal or external to computers 912, 915, or 916.

Portions of the methods described herein may be implemented in suitable software code that may reside within ROM 922, 952, or 962; RAM 924, 954, or 964; or HD 926, 956, or 966. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the present disclosure should be determined by the following claims and their legal equivalents.

What is claimed is:

1. A method, comprising:
providing a user interface to a managerial-level user, the providing performed by an activity flow editor running on a computer, the user interface having a tasks menu for adding tasks to define an activity flow;
responsive to an instruction from the managerial-level user to add a task to the activity flow, prompting the managerial-level user to provide task details and any follow-up task for the task, the prompting performed by the activity flow editor;
storing the activity flow as a building block in a database, the activity flow containing the task and any follow-up task for the task specified by the managerial-level user, the building block comprising code instantiated from a class to implement a setting, the setting including an action, the storing performed by the activity flow editor, the database accessible by a process application; and
responsive to a process administrator inserting the building block into a stage of a lifecycle of an entity using the process application, adding a reference to the entity to an activity flow definition file associated with the building block stored in the database, the adding performed by the process application such that, at runtime of the lifecycle, the activity flow specified by the managerial-level user is automatically executed in the stage of the lifecycle.

2. The method according to claim 1, wherein the tasks menu contains a list of predefined tasks.

3. The method according to claim 1, wherein the activity flow is represented as an entity for querying at runtime.

4. The method according to claim 1, wherein the entity is composed of a plurality of building blocks and wherein the activity flow is one of the plurality of building blocks.

5. The method according to claim 1, wherein the user interface has a settings menu for adding a trigger for the activity flow.

6. The method according to claim 5, wherein the trigger is configured for automatically or manually initiating the activity flow at runtime.

7. The method according to claim 5, wherein the trigger is linked to creation of an instance of the entity, to a condition, to a rule, or to another activity flow.

8. A system, comprising:
a processor;
a non-transitory computer-readable medium; and
stored instructions translatable by the processor for:
providing a user interface to a managerial-level user, the user interface having a tasks menu for adding tasks to define an activity flow;
responsive to an instruction from the managerial-level user to add a task to the activity flow, prompting the managerial-level user to provide task details and any follow-up task for the task;
storing the activity flow as a building block in a database, the activity flow containing the task and any follow-up task for the task specified by the managerial-level user, the building block comprising code instantiated from a class to implement a setting, the setting including an action; and
responsive to a process administrator inserting the building block into a stage of a lifecycle of an entity, adding a reference to the entity to an activity flow definition file associated with the building block stored in the database such that, at runtime of the lifecycle, the activity flow specified by the managerial-level user is automatically executed in the stage of the lifecycle.

9. The system of claim 8, wherein the tasks menu contains a list of predefined tasks.

10. The system of claim 8, wherein the activity flow is represented as an entity for querying at runtime.

11. The system of claim 8, wherein the entity is composed of a plurality of building blocks and wherein the activity flow is one of the plurality of building blocks.

12. The system of claim 8, wherein the user interface has a settings menu for adding a trigger for the activity flow.

13. The system of claim 12, wherein the trigger is configured for automatically or manually initiating the activity flow at runtime.

14. The system of claim 12, wherein the trigger is linked to creation of an instance of the entity, to a condition, to a rule, or to another activity flow.

15. A computer program product comprising a non-transitory computer-readable medium storing instructions translatable by a processor for:
providing a user interface to a managerial-level user, the user interface having a tasks menu for adding tasks to define an activity flow;
responsive to an instruction from the managerial-level user to add a task to the activity flow, prompting the managerial-level user to provide task details and any follow-up task for the task;
storing the activity flow as a building block in a database, the activity flow containing the task and any follow-up task for the task specified by the managerial-level user, the building block comprising code instantiated from a class to implement a setting, the setting including an action; and
responsive to a process administrator inserting the building block into a stage of a lifecycle of an entity, adding a reference to the entity to an activity flow definition file associated with the building block stored in the database such that, at runtime of the lifecycle, the activity flow specified by the managerial-level user is automatically executed in the stage of the lifecycle.

16. The computer program product of claim 15, wherein the activity flow is represented as an entity for querying at runtime.

17. The computer program product of claim 15, wherein the entity is composed of a plurality of building blocks and wherein the activity flow is one of the plurality of building blocks.

18. The computer program product of claim 15, wherein the user interface has a settings menu for adding a trigger for the activity flow.

19. The computer program product of claim 18, wherein the trigger is configured for automatically or manually initiating the activity flow at runtime.

20. The computer program product of claim 18, wherein the trigger is linked to creation of an instance of the entity, to a condition, to a rule, or to another activity flow.
